(19) United States
(12) Patent Application Publication
(10) Pub. No.: US 2005/0073154 A1
(43) Pub. Date: Apr. 7, 2005

(54) Underwater electric generator

(76) Inventor: Maurice Dudley, Atlanta, GA (US)

Correspondence Address: John L. James, P. O. Box 2025, Marietta, GA, 30061-2025, US

(21) Appl. No.: 10/660,268

(22) Filed: Sep. 11, 2003

(51) Int. Cl. H02P 9/04; F03B 13/00

(52) U.S. Cl. 290/54

(57) ABSTRACT

An underwater electrical generating system has an electrical generator and first and second cylinders. Each cylinder has a water inlet and a water outlet. A valve control meters the water flow through the water inlet and water outlet. Each cylinder as a reciprocating piston with a rod that turns the generator to produce electricity. Static water pressure is present in the cylinders when the cylinders are submerged and is used to force the pistons to turn the generator to produce electricity.

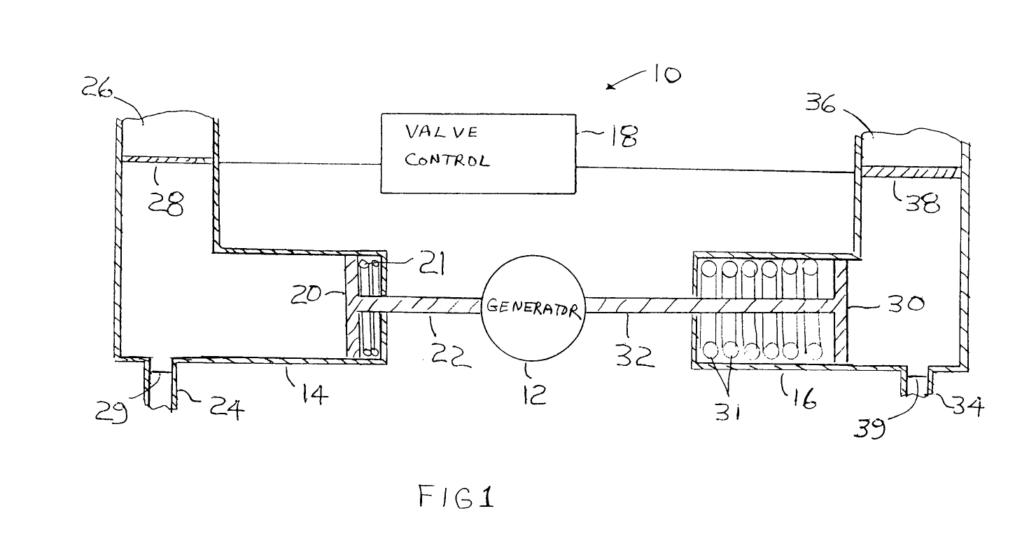

### TECHNICAL FIELD OF THE INVENTION

This invention relates to generation of electricity, and, more particularly, to a method and apparatus for underwater electric generation using static water pressure.

### BACKGROUND OF THE INVENTION

It is desirable to have low cost electrical power. Once a power plant is constructed, one of the most costly aspects of operation is the fuel cost. Coal, oil and natural gas are costly, and nuclear fuel is both costly and hazardous. Hydroelectric generation has virtually no fuel cost. Hydroelectric generators typically employ the kinetic energy of moving water to generate electricity which requires a moving stream of water provided by either an actual moving stream of water or a gravity fed column of water that turns blades of a turbine. It will be appreciated that it would be highly desirable to generate electricity using static bodies of water which are generally more plentiful or can be economically constructed.

### SUMMARY OF THE INVENTION

The present invention is directed to overcoming one or more of the problems set forth above. Briefly summarized, according to one aspect of the invention, an underwater electrical generator comprises an electrical generator and first and second cylinders. Each cylinder has a water inlet and a water outlet. A control device controls the flow of water through the water inlets and the water outlets. A piston is reciprocally mounted in each cylinder. Each piston has a first rod coupled to the generator for turning the generator as the rod extends toward the generator. Static water pressure in the cylinders pushes the piton rods toward the generator to generate electricity.

These and other aspects, objects, features and advantages of the present invention will be more clearly understood and appreciated from a review of the following detailed description of the preferred embodiments and appended claims, and by reference to the accompanying drawings

### BRIEF DESCRIPTION OF THE DRAWING

The drawing is a diagrammatic sectional view of a preferred embodiment of an underwater generator according to the present invention.

### DETAILED DESCRIPTION OF THE PREFERRED EMBODIMENTS

Referring to the drawing, a submerged system 10 for generating electricity includes a generator 12, first and second cylinders 14, 16 and valve controls 18. The system 10 uses the pressure of a static body of water to turn the generator 12 to produce electricity. The deeper the system is submerged, the greater the water pressure and the greater the amount of electricity that can be generated.

The first cylinder 14 has a reciprocating piston 20 with a rod 22 attached thereto with the rod 22 coupled to the generator 12 by appropriate gearing to turn the generator in one direction, clockwise, for example. Piston 20 is preferably equipped with a coil spring 21 which biases piston 20 toward a retracted position of rod 22. First cylinder 14 preferably has a horizontal portion which houses piston 20 and water outlet 24, and a vertical portion which houses water inlet 26. Water inlet 26 is equipped with a valve 28 to control egress of water to piston 20, and water outlet 24 is equipped with valve 29 to control dumping of spent water.

Similarly, the second cylinder 16 has a reciprocating piston 30 with a rod 32 attached thereto with the rod 22 coupled to the generator 12 by appropriate gearing to turn the generator in the same direction as piston 20 and rod 22. Piston 30 is preferably equipped with a coil spring 31 which biases piston 30 toward a retracted position of rod 32. Second cylinder 16 preferably has a horizontal portion which houses piston 30 and water outlet 34, and a vertical portion which houses water inlet 36. Water inlet 36 is equipped with a valve 38 to control egress of water to piston 30, and water outlet 34 is equipped with valve 39 to control dumping of spent water.

Valve control 18 controls opening and closing of valves 28, 29, 38 and 39 so that when valve 28 is open valve 38 is closed and when valve 28 is open valve 29 is closed and valve 39 is open. By this construction, water can enter through water inlet 26 to force piston 20 to extend rod 22 to turn the generator, while valve 38 is closed to remove water pressure so that spring 31 can force spent water out through water outlet 34. At this time valve 29 is closed so that water entering through inlet 26 can pressurize piston 20. Next, valve control 18 closes inlet valve 28 and opens outlet valve 29 allowing spring 21 to force spent water out through water outlet 24. At the same time, valve control 18 closes outlet valve 39 and opens inlet valve 38 allowing the water to pressurize piston 30 to extend rod 32 to turn the generator. This cycling continues repeatedly to generate electricity.

While the invention has been described with particular reference to the preferred embodiments, it will be understood by those skilled in the art that various changes may be made and equivalents may be substituted for elements of the preferred embodiments without departing from invention. For example, while a coil spring has been used to retract the rod, other means could be used to retract the rod. For example, the water pressure could be used to retract the rod by introducing pressurized water to the rod end of the cylinder.

As is evident from the foregoing description, certain aspects of the invention are not limited to the particular details of the examples illustrated, and it is therefore contemplated that other modifications and applications will occur to those skilled in the art. For example, while two cylinders are shown, any number of cylinders could be used. It is accordingly intended that the claims shall cover all such modifications and applications as do not depart from the true spirit and scope of the invention.

1. An underwater electrical generator, comprising:
an electrical generator;
a first cylinder having a first water inlet and a first water outlet;
means for controlling water flow through said first water inlet and said first water outlet;
a first piston reciprocally mounted in said first cylinder having a first rod coupled to said generator for turning said generator as said first rod extends toward said generator;
a second cylinder having a second water inlet and a second water outlet;
means for controlling water flow through said second water inlet and said second water outlet;
a second piston reciprocally mounted in said first cylinder having a second rod coupled to said generator for turning said generator as said second rod extends toward said generator.
